(19) United States
(12) Patent Application Publication
(10) Pub. No.: US 2010/0100438 A1
(43) Pub. Date: Apr. 22, 2010

(54) SYSTEMS AND METHODS FOR MEDIA-INDEPENDENT PROCESSING OF ADVERTISEMENT PUBLICATION INFORMATION

(75) Inventors: Rodney R. Proto, Houston, TX (US); Dana B. Kingshill, Houston, TX (US)

Correspondence Address: CONLEY ROSE, P.C.;David A. Rose, P. O. BOX 3267, HOUSTON, TX, 77253-3267, US

(73) Assignee: ADDOGS, LLC, Houston, TX (US)

(21) Appl. No.: 12/445,007

(22) PCT Filed: Oct. 9, 2007
(86) PCT No.: PCT/US07/80821

§ 371 Date: Apr. 9, 2009

Related U.S. Application Data
(60) Provisional application No. 60/828,748, filed on Oct. 9, 2006.

(51) Int. Cl. G06Q 30/00

(52) U.S. Cl. 705/14.52; 705/14.72

(57) ABSTRACT

The present disclosure describes systems and methods for media-independent processing of advertisement publication information. Some illustrative embodiments include a data processing system including a server computer that includes a data storage device, the data storage device including an advertiser database that includes a source advertisement, and a media outlet database that includes a media outlet record. The server computer is capable of providing the media outlet record for selection by a user. The server computer is further capable of reformatting the source advertisement according to one or more constraints associated with the media outlet record selected by the user.

### CROSS-REFERENCE TO RELATED APPLICATIONS

This application is a non-provisional international application claiming priority to U.S. Provisional Application No. 60/828,748, filed on Oct. 9, 2006, and entitled “System and Methods for Media-Independent Processing of Advertisement Publication Information,” which is hereby incorporated by reference.

### BACKGROUND

Advertisements in printed media have existed for almost as long newspapers and magazines have been in existence. But despite this long history and the advent of computer controlled printing systems, the basic methods and systems used to order and format advertisements have changed very little. Recently, the Internet has provided an additional advertising option with the availability of electronically formatted advertising. However, advertising on Internet websites is also typically purchased in a similar manner as print media. Advertisements are generally submitted to each media outlet individually, and the content and layout of the advertisements are adjusted manually based upon the constraints established by each media outlet, requiring that the same advertisement be recreated over and over again for submission to each media outlet. Such constraints can include the physical limitations of a printed or displayed page or print control characteristics (sometimes referred to as “mechanicals”), unit pricing as well as the basis for the unit itself, time limitations determined by advertisement submission deadlines, and the method for transmission and insertion of the advertisement into the media. The advertisements themselves are sometimes generated by the media outlet based on content provided by the advertiser. Alternatively, the finished advertisement may be provided to the media outlet by the advertiser, or by a third party advertising agency hired by the advertiser.

Although some media outlets have transitioned from taking orders either verbally or by submission of printed copies to accepting orders electronically, such systems are tailored to the constraints of the specific publication. If an advertiser wishes to submit an advertisement to more than one publication, the advertisement must be manually reformatted to comply with each media outlet's constraints as discussed above. Also, each reformatted copy must be submitted separately to each media outlet. Further, different media outlets may each require that the advertisement be submitted in different electronic data formats (sometimes referred to as “insertion methods”). Because of a lack of standardization within the media industry, such constraints can vary significantly from publication to publication. Invoice processing and payment to each media outlet is also handled on a media-outlet-by-media-outlet basis, further increasing the overall transaction costs of securing publication of an advertisement when published in more than one publication.

### BRIEF DESCRIPTION OF THE DRAWINGS

For a detailed description of the illustrative embodiments of the invention disclosed herein, reference will now be made to the accompanying drawings in which:

FIG. 1 shows an advertisement processing system, constructed in accordance with at least some illustrative embodiments;

FIG. 2A shows an example of a computer, suitable for use as a client workstation or a server, and constructed in accordance with at least some illustrative embodiments;

FIG. 2B shows a block diagram of the computer of FIG. 2A, in accordance with at least some illustrative embodiments;

FIG. 3A shows a client/server configuration of advertisement processing software, in accordance with at least some illustrative embodiments;

FIG. 3B shows a configuration of the database of FIG. 3A, in accordance with at least some illustrative embodiments;

FIG. 4 shows a user interface display for performing a media outlet search, in accordance with at least some illustrative embodiments;

FIG. 5A shows a user interface display for applying additional media outlet search filters, in accordance with at least some illustrative embodiments;

FIG. 5B shows a user interface display of the results of a media search, in accordance with at least some illustrative embodiments;

FIG. 6A shows a user interface display for creating an advertisement, in accordance with at least some illustrative embodiments;

FIG. 6B shows a user interface display for selecting the size and publication date of an advertisement, in accordance with at least some illustrative embodiments;

FIG. 7 shows a user interface display for reviewing a final proof of an advertisement, in accordance with at least some illustrative embodiments;

FIG. 8 shows a method for processing an advertisement, in accordance with at least some illustrative embodiments; and

FIG. 9 shows a method for configuring and loading data into a media outlet database, in accordance with at least some illustrative embodiments.

### NOTATION AND NOMENCLATURE

Certain terms are used throughout the following discussion and claims to refer to particular system components. This document does not intend to distinguish between components that differ in name but not function. In the following discussion and in the claims, the terms “including” and “comprising” are used in an open-ended fashion, and thus should be interpreted to mean “including but not limited to . . . .” Also, the term “couple” or “couples” is intended to mean either an indirect or direct connection. Thus, if a first device couples to a second device, that connection may be through a direct electrical connection, or through an indirect electrical connection via other devices and connections.

Additionally, the term “system” refers to a collection of two or more parts and may be used to refer to a computer system or a portion of a computer system. Further, the term “software” includes any executable code capable of running on a processor, regardless of the media used to store the software. Thus, code stored in non-volatile memory, and sometimes referred to as “embedded firmware,” is included within the definition of software. Also, the term “media outlet” refers to an individual or organization that engages in the dissemination of information by publication in any available media, including but not limited to printed media (e.g., newspapers and magazines) and electronic media (e.g., the Internet).

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims, unless otherwise specified. The discussion of any embodiment is meant only to be illustrative of that embodiment, and not intended to intimate that the scope of the disclosure, including the claims, is limited to that embodiment.

Publishers of printed and electronic media derive income from the advertisements placed in their media outlets. These advertisements, which are placed by both businesses and private individuals, must be formatted according to a wide variety of constraints. These constraints may include the physical constraints or “mechanicals” of the page or website on which the advertisements are printed or displayed (e.g., the size of the page, the number of printed columns per page, the font size and type used for the printed or displayed text, and the size of sub-sections or blocks within a page that may be purchased for larger advertisements); economic constraints (e.g., the maximum number of lines allocated to an advertisement given the rate charged for the advertisement); time constraints (e.g., the space available given the deadlines applicable to the section in which the advertisement is to placed); and insertion method constraints (i.e., what data format is accepted by a media outlet). Although different media outlets may have significantly different constraints, it is possible to subdivide an advertisement into blocks or elements, and to re-position and/or re-size the elements in order to comply with at least some of the constraints of a given media outlet. Further, other constraints, such as the insertion method, can be met by reformatting the data without significantly altering the advertisement layout itself. Thus, a single, source advertisement may be processed by a computer system to produce multiple variations of the advertisement, each complying with the constraints of a different target media outlet.

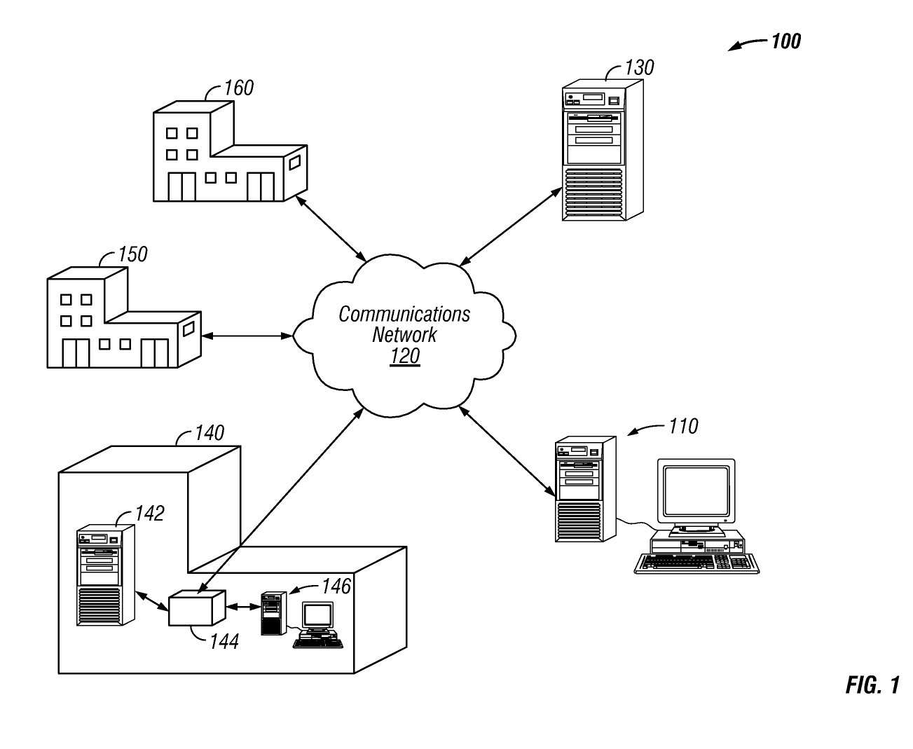

FIG. 1 shows a system 100 for processing an advertisement. Client workstation 110 is operated by an advertiser to input an advertisement to system 100. The advertisement may be generated using hardware and software external to client workstation 110, or may be created using client workstation 110. The advertiser interacts with the system 100 via client workstation 110, as described below. Client workstation 110 couples to server 130 via communications network 120 (e.g., the Internet). Software executing on both client workstation 110 and server 130 operate together to process the advertisement that is input to the system, and to produce multiple processed versions of the advertisement. Server 130 couples to computer systems operated by multiple media outlets (e.g., media outlets 140, 150 and 160) via communications network 120, and sends to each media outlet a version of the processed advertisement that complies with the corresponding media outlet's constraints. In the illustrative embodiment shown in FIG. 1, each media outlet couples to communications network 120 via a network interface device (e.g., network hub 144 shown as part of media outlet 140's facilities), which provides connectivity to the media outlet's servers and workstations (e.g., media outlet server 142 and media outlet workstation 146).

Although client workstation 110, server 130 and the servers and workstations used by media outlets 140, 150 and 160 are shown coupled to each other through a single network, separate networks may be used to transfer the advertisement data, as well as other, non-networked media such as floppy disks and compact disk read-only memories (CD ROMs). Other media for communicating the advertisement data between elements of system 100 will become apparent to those of ordinary skill in the art, and all such media are intended to be within the scope of the present disclosure.

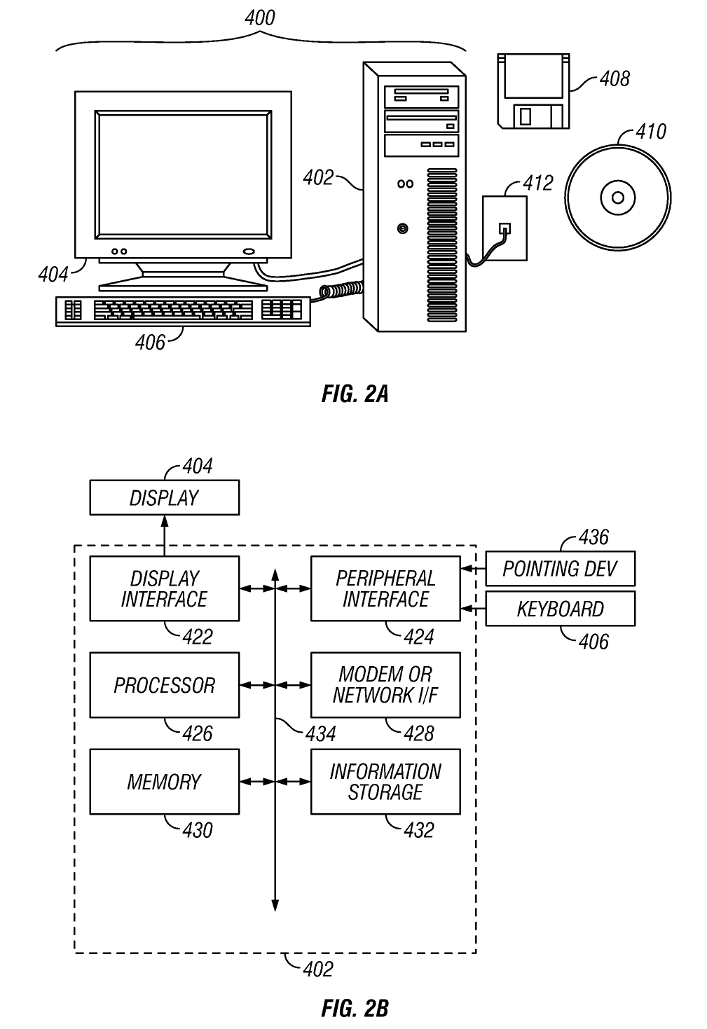

FIGS. 2A and 2B show an illustrative system configuration 400 suitable for implementing client workstation 110, server 130, media outlet's server 142, and media outlet's workstation 146 of FIG. 1. As shown, the illustrative system configuration 400 includes a chassis 402, a display 404, and an input device 406. The chassis 402 includes a processor 426, memory 430, and information storage device 432. One or more information storage devices 432 may store programs and data on removable storage media such as a floppy disk 408 or an optical disc 410. The chassis 402 also includes a network interface 428 that allows the system 400 to receive information via a local area network (e.g., Internet 120 of FIG. 1) and/or a wired or wireless wide area network, represented in FIG. 2A by a phone jack 412. The information storage media and information transport media (i.e., the networks) are collectively called “information carrier media.” The chassis 402 is coupled to the display 404 and the input device 406 to interact with a User. The display 404 and the input device 406 may together operate as a user interface. The input device 406 is shown as a keyboard, but other input devices such as a mouse or a keypad may also be included.

FIG. 2B shows a simplified functional block diagram of system 400. The chassis 402 may include a display interface 422, a peripheral interface 424, a processor 426, a modem or other suitable network interface 428, a memory 430, an information storage device 432, and a bus 434. System 400 may be a bus-based computer, with the bus 434 interconnecting the other elements and carrying communications between them. The display interface 422 may take the form of a video card or other suitable display interface that accepts information from the bus 434 and transforms it into a form suitable for the display 404. Conversely, the peripheral interface 424 may accept signals from the keyboard 406 and other input devices such as a pointing device 436, and transform them into a form suitable for communication on the bus 434.

The processor 426 gathers information from other system elements, including input data from the peripheral interface 424, and program instructions and other data from the memory 430, the information storage device 432, or from other systems coupled to a local area network or a wide area network via the network interface 428. The processor 426 carries out the program instructions and processes the data accordingly. The program instructions may further configure the processor 426 to send data to other system elements, including information for the User which may be communicated via the display interface 422 and the display 404. The network interface 428 enables the processor 426 to communicate with other systems via a local area network or via a wide area network. The memory 430 may serve as a low-latency temporary store of information for the processor 426, and the information storage device 432 may serve as a long term (but higher latency) store of information.

The processor 426, and hence the computer 400 as a whole, operates in accordance with one or more programs stored on the information storage device 432 or received via the network interface 428. The processor 426 may copy portions of the programs into the memory 430 for faster access, and may switch between programs or carry out additional programs in response to User actuation of the input device. The additional programs may be retrieved from the storage device 432 or may be retrieved or received from other locations via the network interface 428. One or more of these programs executes on system 400 causing it to perform at least some of the advertisement processing functions disclosed herein.

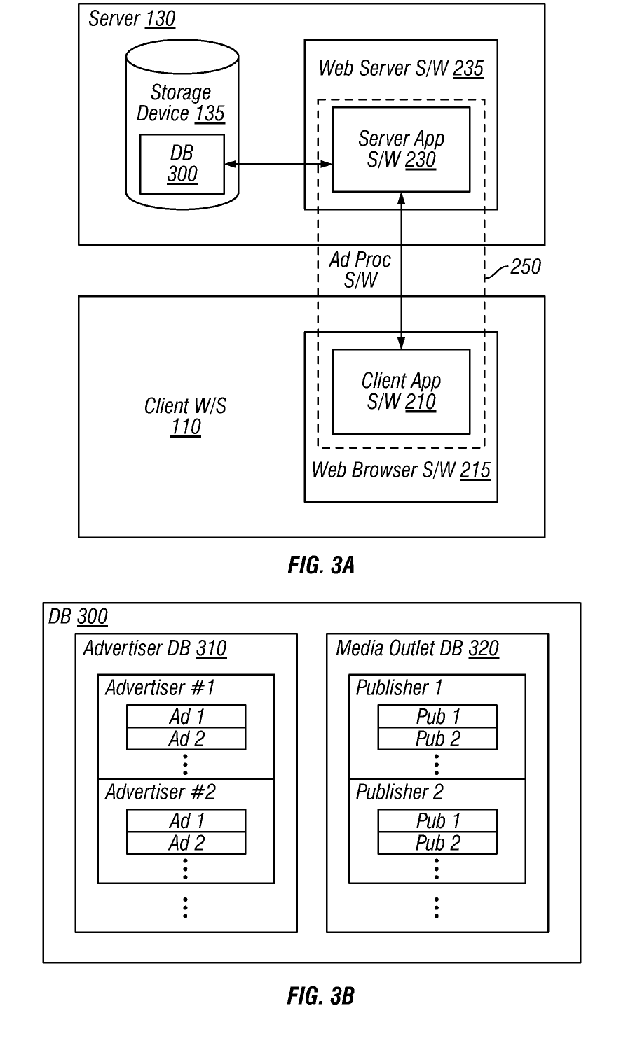

As shown in the illustrative embodiment of FIGS. 3A and 3B, client application software 210 and server application software 230 (executing on client workstation 110 and server 130 respectively) operate in unison as advertisement processing software 250. The functionality of advertisement processing software 250 may be distributed between the client and server components in a number of different ways. In at least some illustrative embodiments, most of the data manipulation and processing is concentrated in server application software 230, resulting in a “thin” client implementation of client application software 210, which provides the user interface. Such a thin client may be implemented as a web-based client using the hypertext markup language (HTML), Java™, or other similar browser-based software. Client application software 210 executes within the environment provided by web browser software 215 (e.g., Microsoft® Internet Explorer or Mozilla® Firefox®), which executes on client workstation 110. Client application software 210 communicates and interacts with server application software 230, which executes within the environment created by web server software 235 (e.g., Apache web server software), which in turn executes on server 130.

By using a thin, web-based client and implementing the data processing functions on the server, application specific software does not need to be expressly installed onto client workstation 210. An advertiser can simply execute web browser software 215 on client workstation 110 and visit a service provider's website, which provides the advertiser with access to server application software 230 by executing client application software 210 within the web browser. Client application software 210 provides the user interface that allows the advertiser to upload an existing source advertisement to server 130 or create a source advertisement for uploading to the server 130. In at least some illustrative embodiments, the data file may be created at client workstation 110 using client application software 210. The source advertisement is in the form of a data file that describes the advertisement data and uses any suitable upload data format. For example, the upload data format may include a file format such as the Adobe® portable document format (PDF), the Adobe® InDesign® interchange file format (sometimes referred to as “INX” files), and the QuarkExpress® document format (sometimes referred to as “QXD” files). Some of these upload data formats (“closed” upload data formats), such as the PDF upload data format, do not permit individual elements of the source advertisement to be reformatted. Other upload data formats (“adjustable” upload data formats), such as the INX and QXD upload data formats, do permit manipulation and reformatting of individual elements of the source advertisement represented. A source advertisement represented by an adjustable upload data format may include any number of elements, such as the text elements of the source advertisement, as well as graphical elements such as logos, images, and watermarks, just to name a few examples. Those skilled in the art will recognize that many other data and file formats may be suitable for describing source advertisements, and all such data and file formats are intended to be within the scope of the present disclosure.

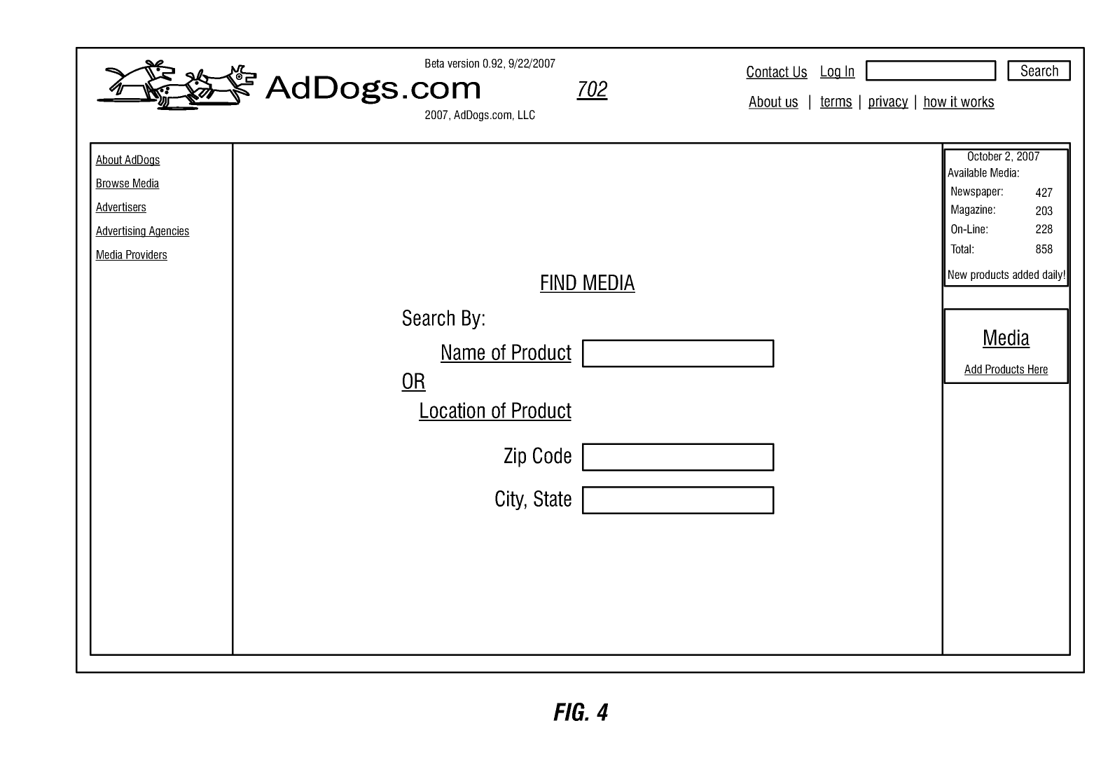

Continuing to refer to FIGS. 3A and 3B, the data file, once uploaded or created, is stored in advertiser database 310, one of several databases maintained within database 300 (e.g., a Sybase® or Oracle® relational database) and saved on storage device 135 within server 130. This allows the advertiser to recall stored source advertisements at a later time and use them again, either in their original form or with modifications. After the data file has been uploaded or created, the advertiser is then prompted to select one or more media outlets (e.g., via display 702 as shown in FIG. 4). These media outlets may be selected individually from a list determined by geographic and/or demographic information provided by the advertiser. For example, if the advertiser wishes to publish an advertisement in the New York metropolitan area, a selection list is provided to the advertiser that includes the New York Times® and the New York Post®, but not the Houston Chronicle®. Other criteria for building selection lists will become apparent to those skilled in the art, and all such criteria are intended to be within the scope of the present disclosure.

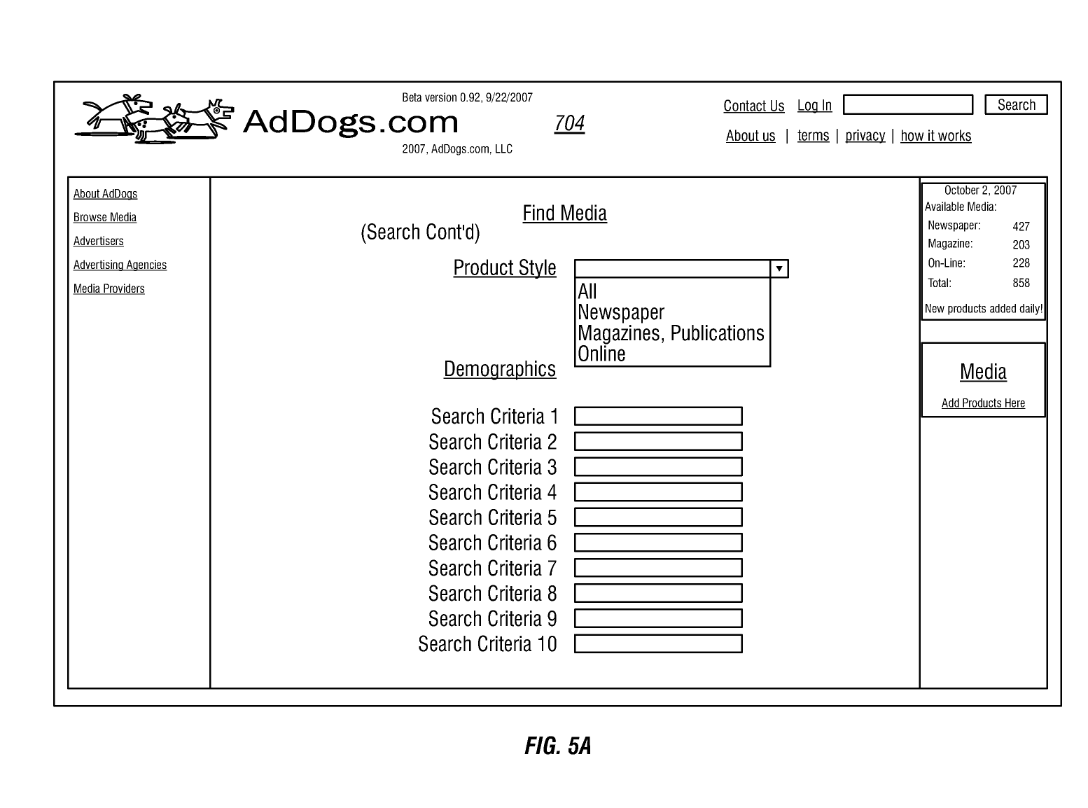

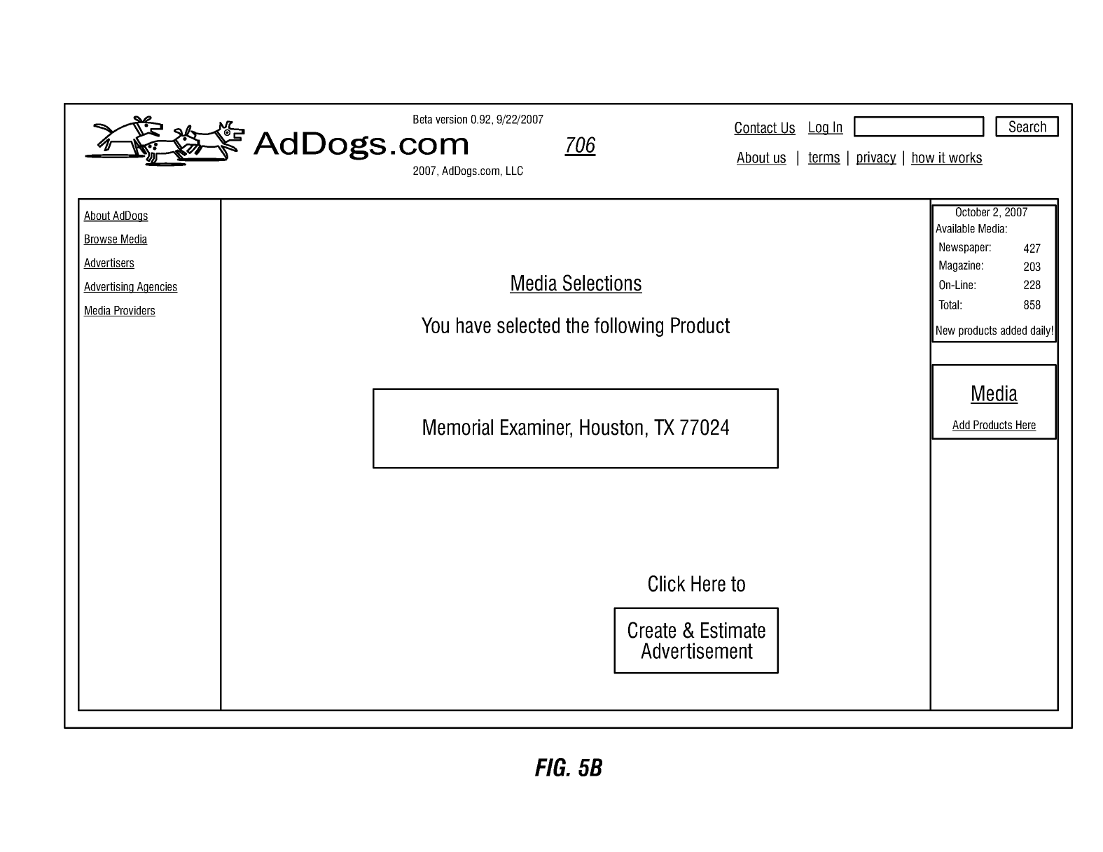

In some metropolitan areas, the number of media outlets available for selection may be quite extensive, making the selection process somewhat cumbersome. In at least some illustrative embodiments, filters (e.g., via display 704 as shown in FIG. 5A) allow the user to define additional search parameters or filters that limit the selection of media outlets to a more manageable number, resulting in the presentation of filtered subsets of media outlets to the user (e.g., via display 706 as shown in FIG. 5B). The filtering criteria may include one or more zip codes, a geographic sub-region (e.g., Manhattan rather than New York City), a radius around or about a geographic reference point (e.g., the center of a region for a particular zip code, the center of a county, etc.), the type of advertising to be done (e.g., help wanted, selling a car, etc.), or a particular media outlet profile (e.g., circulation frequency, type of publication, etc.). Many other criteria for filtering the list of available media outlets will become apparent to those of ordinary skill in the art, and all such criteria are within the scope of the present disclosure.

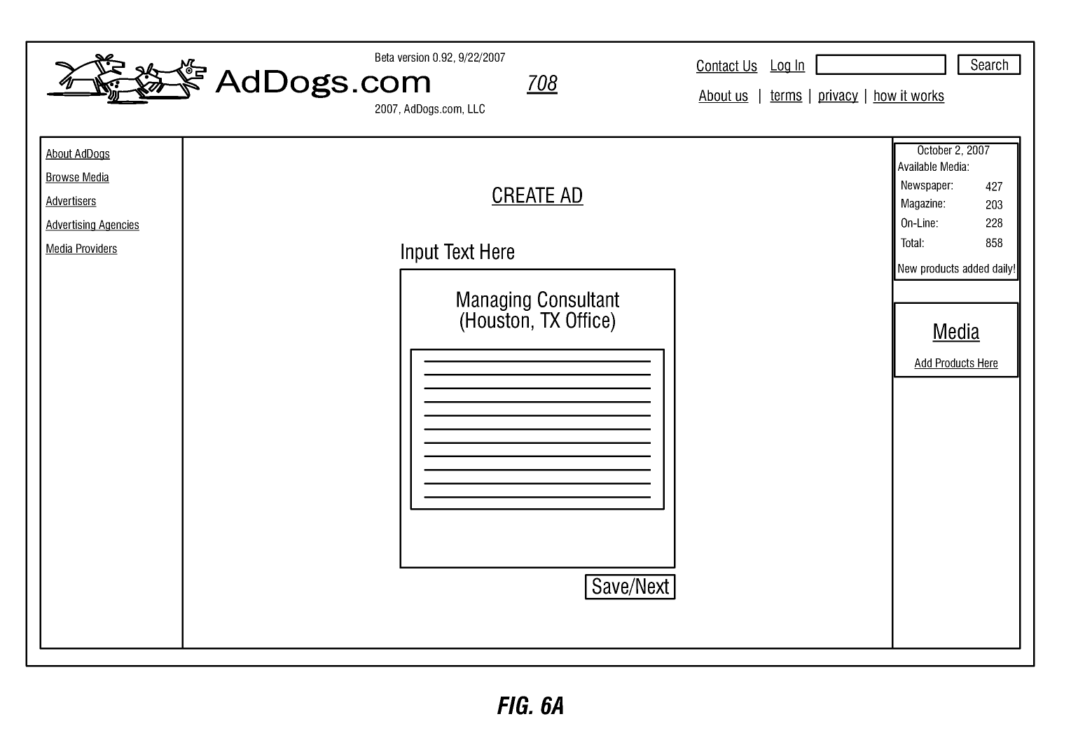

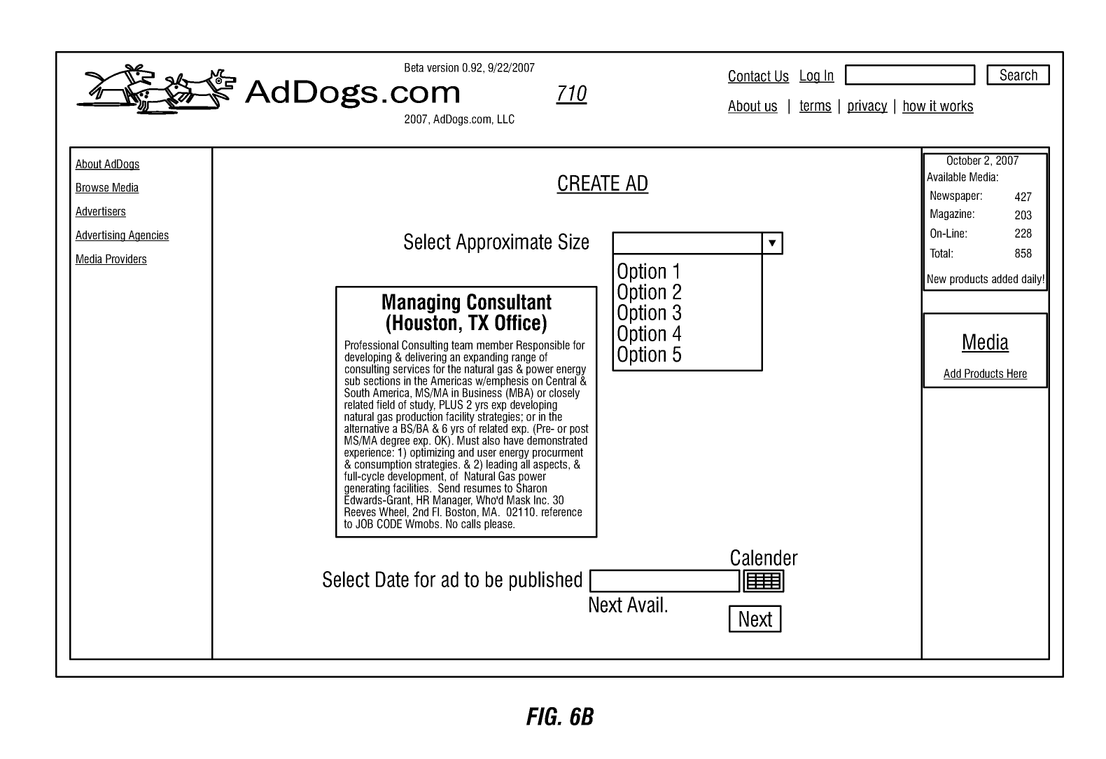

For each media outlet selected, the advertiser is also prompted to select an advertisement size. The selection of advertisement sizes that are made available to the advertiser will depend upon the upload data format used to represent the advertisement. Closed upload data formats, such as the Adobe® portable document format (PDF), do not allow reformatting of individual elements within the document, thus limiting the number of available advertisement sizes to those that can accommodate the advertisement as submitted. System created advertisements (e.g., created via display 708 as shown in FIG. 6A) or other uploaded data formats, such as INX and QXD upload data formats which do allow reformatting of individual elements, may be used with a larger variety of advertisement sizes since they can be modified to conform to at least some of the media outlet constraints.

The advertisement sizes made available to the advertiser can be based upon one or more filtering criteria. In at least some illustrative embodiments, an advertiser can specify pricing, and start/end dates, and the list of available sizes that is presented to the advertiser may be tailored to show only those sizes for the selected publications that meet the criteria (e.g., via display 710 as shown in FIG. 6B). Thus, for example, if a source advertisement is uploaded or created that uses a PDF upload data format, to run starting on Monday and ending on Friday of the following week, and limited by a budget of $1,000, the advertisement processing software would not attempt to reformat the source advertisement (since it is a closed upload data format) and would display only those advertisement sizes that meet the remaining criteria and which would physically fit in the space available for the advertisement. In other illustrative embodiments, the advertiser may use a more open filtering criterion. For example, the advertiser may decide not to specify pricing limitations, thus resulting in a larger number sizing options being presented to the advertiser.

In other illustrative embodiments, a source advertisement that uses adjustable upload data formats permits the advertisement processing software to offer more options to the advertiser, once the source advertisement has been processed. Each advertisement size offered by a media outlet has a set of media outlet constraints or mechanicals associated with it, which are stored in media outlet database 320 of FIGS. 3A and 3B, and each record in media outlet database 320 is maintained by each of the corresponding media outlets. Once an advertiser has selected an advertisement size, the media outlet mechanicals associated with the selected size are applied by server application software 230 to the source advertisement to determine whether the advertisement as submitted will fit in the space available for the selected size. If it does not, the software will attempt to reformat the advertisement by repositioning and resizing the various elements that make up the advertisement.

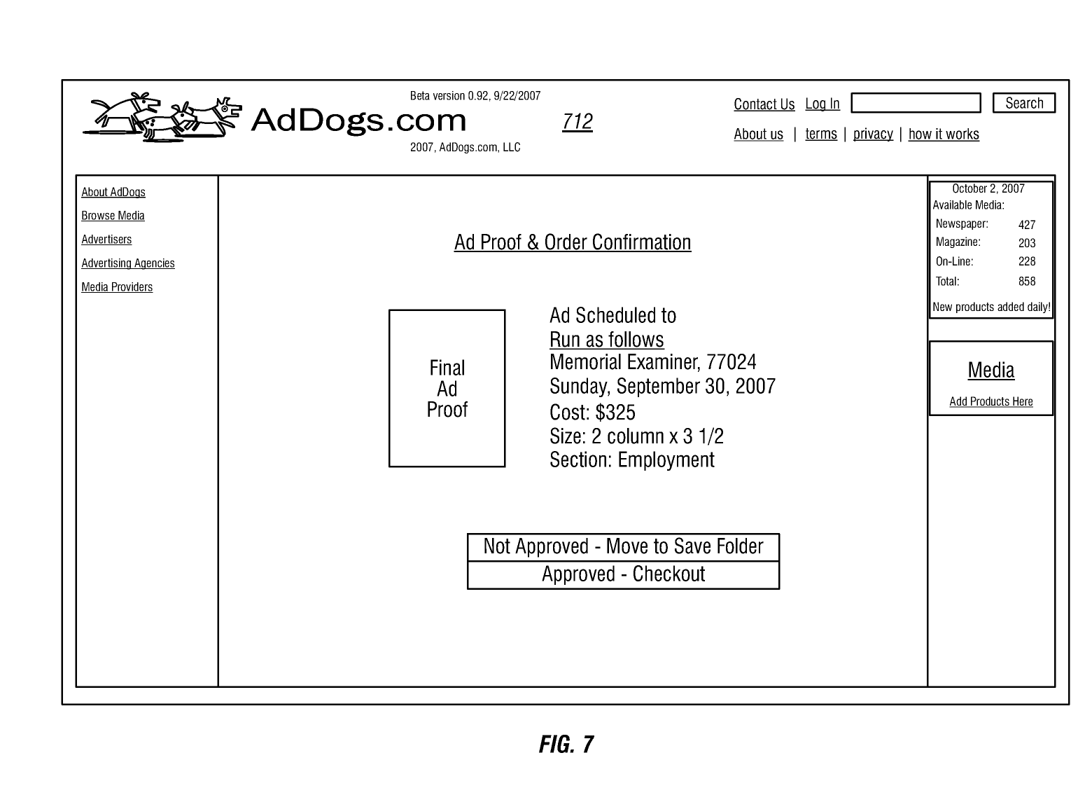

Once an advertisement meets all the constraints for a given size (either with or without reformatting), the resulting processed advertisement is displayed to the advertiser at client workstation 110 (e.g., via display 712 as shown in FIG. 7). This allows the advertiser to visually inspect the advertisement to determine if the advertisement is acceptable as it will be published. Such proofing may be made on a publication-by-publication basis, or on a size-by-size basis for cases where multiple publications share one or more common sizes. In at least some illustrative embodiments, the advertiser may enter one or more tolerance parameters. A first, more tightly constrained size may then be used with other publications if the other publications each use less constrained sizes with dimensions and limitations that are different from the dimensions and limitations of the first size by no more than the corresponding tolerance parameters. In this manner a single, reformatted advertisement may be sent to multiple media outlets even though the media outlets each have slightly different constraints.

If an advertisement does not conform to the constraints for a given size or other defined requirements (e.g., mechanicals) to the satisfaction of the advertiser, the advertiser is given the option to either select a different size, or upload or create a modified source advertisement, or both. In at least some illustrative embodiments, the advertiser may be given the option of modifying at the client workstation the source advertisement already loaded on the server. Once the new selection and/or modification are made, the mechanicals corresponding to the selected size are again applied to the advertisement, and the process is repeated until the advertisement conforms to the constraints of the selected sizes to the satisfaction of the advertiser. The process of conforming advertisements to selected sizes is repeated until reformatted advertisements suitable for all of the selected publications have been generated. In at least some illustrative embodiments, the reformatted advertisements are saved on storage device 135 within advertiser database 310.

After the reformatted advertisements have been generated, the advertiser is prompted for payment of the total amount for publishing the reformatted advertisements in all of the selected publications. The amount is based at least in part upon the selected advertisement sizes and time durations selected for each publication. The advertiser may pay the required fees using any number of payment methods (e.g., credit card, debit card, PayPal®, or commercial credit account). The payment is made to a service provider that makes the advertisement processing software 250 available via the service provider's website. The service provider in turn makes the necessary payments to the media outlets, possibly deducting a commission as a fee for securing the sale of the advertisements. Other payment methods and fee arrangements will become apparent to those skilled in the art, and all such payment methods and fee arrangements are intended to be within the scope of the present disclosure.

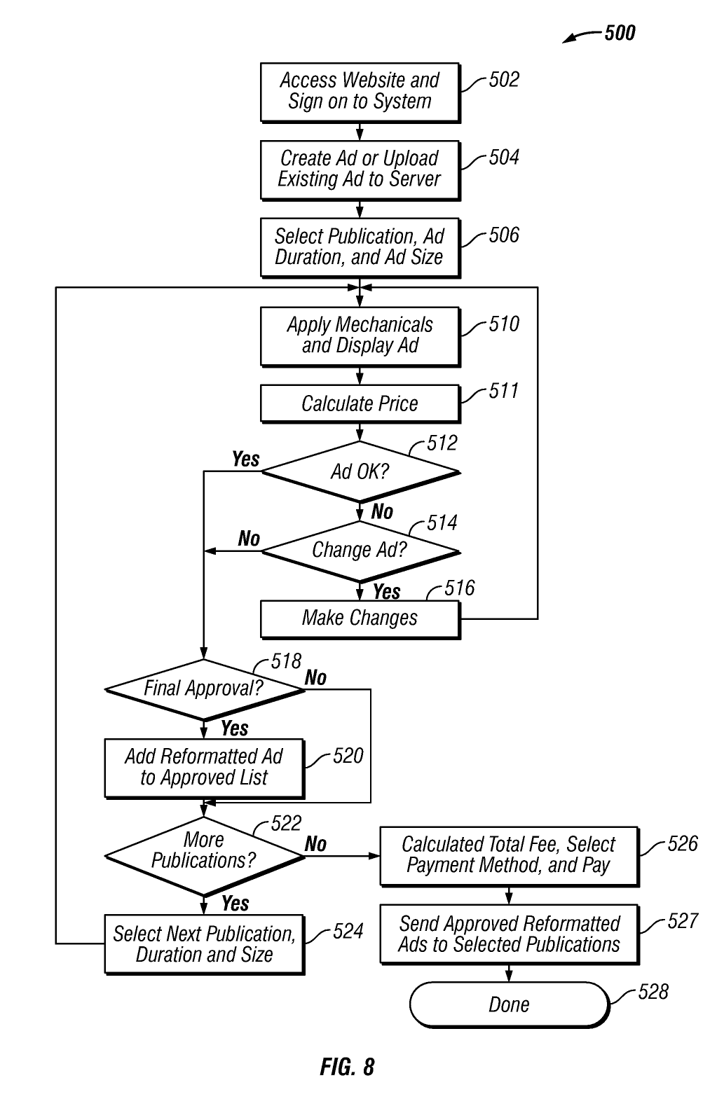

FIG. 8 shows a method 500 that implements the process described above, in accordance with at least some illustrative embodiments. An advertiser accesses a service provider's website by providing a user ID and password to log into the advertisement processing system (block 502). Once logged in, the advertiser uploads or creates the advertisement data file to the service provider's server (block 504). The advertiser also selects one or more publications, advertisement publication durations for each publication, and the advertisement sizes desired for each publication (block 506). The applicable mechanicals are applied to the uploaded or created advertisement in accordance with the media outlets constraints (stored on the service provider's server), and the results are displayed (block 510). After applying the first mechanical to the source advertisement, the price of the advertisement is calculated based on the selected size (block 511).

After the initial processing of the advertisement using the first selected size, the advertiser is shown the resulting reformatted advertisement and its price. If the displayed reformatted advertisement does not meet the advertiser's initial approval (block 512), the advertiser is prompted to select whether or not to modify the advertisement. If the advertiser chooses to make changes (block 514), the changes are made to either the advertisement or one of the selected parameters (e.g., size, rate, and duration) (block 516), and the process is repeated with the modified parameters (blocks 510-516). This allows the advertiser to make changes to improve the overall appearance of the advertisement, reduce the cost, or both.

If the advertisement is initially approved by the advertiser (block 512) or the advertiser chooses not to make any additional changes (block 514), the advertiser is prompted to give final approval to the reformatted advertisement for publication as requested (block 518). If the advertiser approves, the reformatted advertisement is added to an approved list (block 520). Once an advertisement is approved or not approved, a check is made to determine if there are more publications to be processed (block 522). If there are still publications requiring processing, another publication of the remaining unprocessed publications is selected (block 524), and the reformatting process is repeated (blocks 510-522). If all publications have been processed (block 522), the total fees for the requested advertisements are calculated based upon the advertisements in the approved list, and payment is made by the advertiser using any of a number of payment methods presented to and selected by the advertiser (block 526). Once payment is complete, the reformatted advertisements may be sent to each media outlet (block 527) using the insertion method required by each media outlet, completing method 500 (block 528). Thus, a single source advertisement can be used to produce any number of processed advertisements, which are then sent to multiple media outlets based on the advertiser's selections.

In addition to the interface provided to advertisers by the client application software, similar media outlet application software is provided, which executes on a media outlet workstation (e.g., media outlet workstation 146 of FIG. 1). The media outlet application software is also a “thin” client, which provides the media outlet with an interface to server 130. This interface allows media outlets to create and maintain records in the media outlet database for use by advertisers placing orders for advertisements. These records are organized by publication, and further by available sizes, and include such data as the media outlet's constraints or “mechanicals”, pricing (including specials and package deals), submission deadline information, and acceptable insertion methods. Other relevant information that may be included in the media outlet database will become apparent to those skilled in the art, and all such information is intended to be within the scope of the present disclosure.

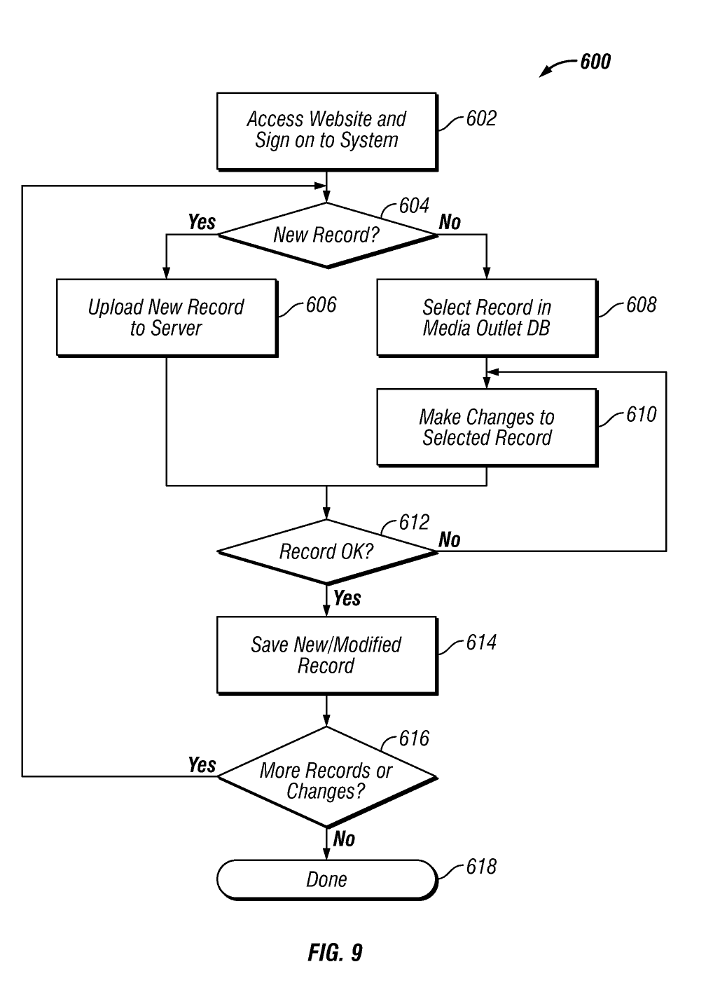

FIG. 9 shows a method 600 that implements a media outlet's interface to the advertisement processing system, in accordance with at least some illustrative embodiments. A media outlet user accesses a service provider's website by providing a user ID and password to log into the advertisement processing system (block 602). Once logged in, the media outlet user is prompted to select between providing a new publication record, or to modify an existing publication record (block 604). If a new publication record is to be added, the media outlet user uploads the new record (block 606). If an existing publication record is to be modified, the media outlet user selects a publication record within the media outlet database (block 608) and makes the desired changes to the record (block 610). Once a record has been either uploaded or modified, the new/modified record is reviewed by the media outlet user, and if approved (block 612) the record is saved to the database (block 614). If the record is not approved, the media outlet user is given an opportunity to modify the record (block 610) and again review and approve it (block 612). The review process may also include additional automated consistency checks to verify that any modifications or additions do not generate errors when the record is later used by an advertiser. Once the record is saved (block 614) the media outlet user may continue adding/modifying records if desired (block 616). Otherwise method 600 is complete (block 618).

The systems and methods described above combine to provide a unified, one stop shopping service that allows an advertiser to place advertisements with multiple media outlets in multiple publications, while maintaining the time, effort, and overall transaction costs associated with placing advertisements at a lower level when compared to placing advertisements in multiple publications individually. Many additional enhanced capabilities are contemplated, and include an editor for graphically creating and modifying advertisements at the client workstation (either as a separate software program, or as part of the client application software), application of constraints according to a priority scheme, and a “My Account” feature that permits both advertisers and media outlets to more easily track data within their respective databases, including user-defined database record fields (e.g., a notes field for saving comments describing the success or failure of an advertisement).

The above disclosure is meant to be illustrative of the principles and various embodiments of the present invention. Numerous variations and modifications will become apparent to those skilled in the art once the above disclosure is fully appreciated. For example, although the present disclosure describes embodiments that produce advertisements suitable for use in printed media, other embodiments may also generate advertisements formatted for use in electronic or Internet-based publications. Also, even though the embodiments described incorporate web-based client application software, other embodiments may include stand-alone programs that execute on the client workstation. Furthermore, the order of the steps taken by an advertiser to process an advertisement in the embodiments described may be different in other embodiments that are within the scope of the present disclosure. It is intended that the following claims be interpreted to embrace all such variations and modifications.

What is claimed is:

1. A data processing system, including:
a server computer that includes a data storage device, the data storage device including:
an advertiser database that includes a source advertisement; and
a media outlet database that includes a media outlet record;
wherein the server computer is capable of providing the media outlet record for selection by a user; and
wherein the server computer is further capable of reformatting the source advertisement according to one or more constraints associated with the media outlet record selected by the user.

2. The data processing system of claim 1, wherein the server computer is further capable of causing a reformatted advertisement to be presented to the user, and further capable of causing the user to be prompted to accept or reject the reformatted advertisement.

3. The data processing system of claim 1, wherein the server computer is further capable of transmitting a digital representation of a reformatted advertisement to a media outlet server associated with the selected media outlet record, if the user signals acceptance of the reformatted advertisement.

4. The data processing system of claim 3, wherein the reformatted advertisement is transmitted to the media outlet server according to an insertion method associated with the selected media outlet record.

5. The data processing system of claim 1, wherein the server computer is further capable of transmitting a digital representation of a reformatted advertisement to a plurality of media outlet servers that are each uniquely associated with one of a plurality of media outlet records selected by the user, if the user signals acceptance of the reformatted advertisement.

6. The data processing system of claim 1, wherein a digital representation of the source advertisement includes one or more elements, and wherein reformatting the source advertisement includes changing at least one characteristic of an element of the one or more elements selected from the group of characteristics consisting of the position of the element, the size of the element, and the font type of text within the element.

7. The data processing system of claim 1, wherein the one or more constraints includes at least one constraint select from the group consisting of the dimensions of a printed page, the dimensions of a displayed web page, a rate charged for publication of a reformatted advertisement, and a deadline for transmitting the reformatted advertisement to the media outlet server.

8. The data processing system of claim 1,
wherein the media outlet database includes a plurality of media outlet records, and the server computer is capable of providing a filtered subset of the plurality media outlets records for selection by the user; and
wherein each media outlet record of the filtered subset is presented based upon at least one filtering criteria selected from the group consisting of a zip code, a geographic sub-region, a radius about a geographic reference point, a type of advertising, and a media outlet profile.

9. A method, including:
storing a digital representation of a source advertisement;
saving a selection, made by a user, of a media outlet from a plurality of media outlets, the selected media outlet associated with one or more constraints that establish limits to reformatting a stored source advertisement; and
reformatting the source advertisement according to the one or more constraints defined by the selected media outlet.

10. The method of claim 9, further including:
displaying to the user a modified advertisement that results from reformatting the source advertisement; and
prompting the user to accept or reject the modified advertisement.

11. The method of claim 9, further including sending a digital representation of a modified advertisement to a computer associated with the selected media outlet, if the user signals acceptance of the modified advertisement.

12. The method of claim 11, wherein sending the digital representation of the modified advertisement includes providing the modified advertisement to the media outlet in accordance with an insertion method associated with the media outlet.

13. The method of claim 9, further including sending a digital representation of a modified advertisement to a plurality of computers that are each uniquely associated with one of a plurality of media outlets selected by the user, if the user signals acceptance of the modified advertisement.

14. The method of claim 9, wherein reformatting the source advertisement includes changing at least one characteristic associated with an element of the source advertisement, the at least one characteristic selected from the group consisting of the position of the element, the size of the element, and the font type of text within the element.

15. The method of claim 9, wherein the one or more constraints include at least one constraint selected from the group consisting of the dimensions of a printed page, the dimensions of a displayed web page, a rate charged for publication of a modified advertisement, and a deadline for transmitting the modified advertisement to the media outlet server.

16. The method of claim 9, further including presenting to the user for selection a filtered subset of the plurality of media outlets, each media outlet of the filtered subset presented based upon at least one filtering criteria selected from the group consisting of a zip code, a geographic sub-region, a radius about a geographic reference point, a type of advertising, and a media outlet profile.

17. A computer-readable medium including software that causes a processor to:
store a digital representation of a source advertisement;
save a selection, made by a user, of a media outlet from a plurality of media outlets, the selected media outlet associated with one or more constraints that establish limits to reformatting a stored source advertisement;
reformat the source advertisement according to the one or more constraints defined by the selected media outlet;
display to the user a modified advertisement that results from reformatting the source advertisement; and
prompt the user to accept or reject the modified advertisement.

18. The computer-readable medium of claim 17, wherein the software further causes the processor to send a digital representation of the modified advertisement to a computer associated with the selected media outlet, if the user signals acceptance of the modified advertisement.

19. The computer-readable medium of claim 18, wherein the software further causes the processor to send the digital representation of the modified advertisement includes causing the processor to provide the modified advertisement to the media outlet in accordance with an insertion method associated with the media outlet.

20. The computer-readable medium of claim 17, wherein the software further causes the processor to send the digital representation of the modified advertisement to a plurality of computers that are each uniquely associated with one of a plurality of media outlets selected by the user, if the user signals acceptance of the modified advertisement.

21. The computer-readable medium of claim 17, wherein the software further causes the processor to reformat the source advertisement includes causing the processor to change at least one characteristic associated with an element of the source advertisement, the at least one characteristic selected from the group consisting of the position of the element, the size of the element, and the font type of text within the element.

22. The computer-readable medium of claim 17, wherein the one or more constraints include at least one constraint selected from the group consisting of the dimensions of a printed page, the dimensions of a displayed web page, a rate charged for publication of the modified advertisement, and a deadline for transmitting the modified advertisement to the media outlet server.

23. The computer-readable medium of claim 17, wherein the software further causes the processor to present to the user for selection a filtered subset of the plurality of media outlets, and wherein each media outlet of the filtered subset is presented based upon at least one filtering criteria selected from the group consisting of a zip code, a geographic sub-region, a radius about a geographic reference point, a type of advertising, and a media outlet profile.
